(19) United States
(12) Patent Application Publication
(10) Pub. No.: US 2026/0056046 A1
(43) Pub. Date: Feb. 26, 2026

(54) MOLDED METER PIT FRAME

(71) Applicant: Bingham & Taylor Corp., Rocky Hill, CT (US)

(72) Inventors: James Bryant, Culpeper, VA (US); Jacob Butcher, Fredericksburg, VA (US); Dennis Quinn, Boston, VA (US)

(73) Assignee: Bingham & Taylor Corp., Rocky Hill, CT (US)

(21) Appl. No.: 19/251,966

(22) Filed: Jun. 27, 2025

Related U.S. Application Data
(60) Provisional application No. 63/686,476, filed on Aug. 23, 2024.

(51) Int. Cl. G01F 15/14

(52) U.S. Cl. CPC G01F 15/14

(57) ABSTRACT

Systems and methods are disclosed for a meter pit frame that is configured to enclose an opening of a meter pit. The meter pit frame includes an outer frame edge, a circular inner wall defining a central opening from which extends a lip for receiving and supporting a cover, and a plurality of ribs disposed entirely on the underside of the meter pit frame and beneath the top surface thereof, the ribs extending between the inner wall and the outer frame edge and configured to enable the meter pit frame to support vertical loading. The meter pit frame is molded from plastic and is configured to enable transmission of data signals therethrough. Expander rings and/or extension components may be employed to enable the meter pit frame to be secured to meter pits having different diameters or lengths.

### CROSS REFERENCE TO RELATED APPLICATIONS

This application claims the benefit of priority to U.S. Provisional Patent Application Ser. No. 63/686,476 filed on Aug. 23, 2024, the entire disclosure of which is incorporated herein by reference for all purposes.

### FIELD OF THE INVENTION

The present disclosure relates to molded meter pit frames, including without limitation molded frames that enable a lid to be installed on a meter pit while allowing signal and data transmission therethrough.

### BACKGROUND

The present disclosure relates to a frame for any kind of underground box, housing or container that houses utility equipment, regardless of its function. For the purposes of simplicity only, such underground boxes, housings and/or containers are referred to collectively herein as meter pits, although it should be recognized that the present disclosure is not limited to any particular type of meter pit or any particular function, e.g., metering. Thus, while the term meter pit is used herein, its should be appreciated that such term refers to any type of utility box including, without limitation, valve boxes, curb boxes, meter boxes, valve vaults, meter vaults, etc.

Generally, meter pits are very commonly employed by, e.g., municipalities or other utility-providing or servicing entities and the like, to house—typically underground—equipment and/or instruments of varying types, such as water and/or gas flow meters, monitoring instruments, e.g., leak detection instruments, and the like. Often, these monitoring or metering instruments, e.g., employ an antenna so as to transmit signals related thereto, such as a signal related to the flow of water or gas, a signal indicating that a leak has occurred, a signal providing geolocation data, etc. Ideally, the lid of such a meter pit is able to transmit such a signal through the lid (since a person is not physically present to remove the lid first).

Such monitoring instruments, and the antennae employed therewith, often come in a variety of different sizes and types. However, such water or utility meter box lids suffer from certain challenges, e.g., an inability to effectively ensure that the lid allows signals to be transmitted therethrough.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The molded meter pit frame system described hereinbelow, according to various embodiments, addresses various challenges facing previously-employed meter pit frame systems. For example, historically, meter pit frame systems have been manufactured from cast iron, which—although they have provided adequate longevity, strength and cost—have various drawbacks. One such drawback of cast iron meter pit frame systems is that they provide poor radio and cellular signal transmission. Another such drawback of cast iron meter pit frame systems is that they are very heavy, making them difficult to ship, carry and install. Still another such drawback of cast iron meter pit frame systems is that they are difficult to modify or trim in the field should they need to be trimmed or adjusted. Yet another drawback of cast iron meter pit frame systems is that they can tend to rust over time, resulting in an unsightly appearance.

As mentioned above and as will be apparent from the various embodiments set forth below, the molded meter pit frame system described herein may address one or more of these various challenges. For example, in various embodiments, the molded meter pit frame system described herein are manufactured from molded plastic, e.g., polypropylene, or composite, e.g. glass reinforced polypropylene or resins. Unlike casting the meter pit frame system from iron, the molded meter pit frame systems described herein may provide improved radio and cellular signal transmission such as by reducing the amount of metal around the transmitters, e.g., automated meter reading (“AMR”) technologies.

Furthermore, unlike cast iron meter pit frame systems, which can be very heavy, the molded meter pit frame systems described herein may provide a significant reduction in weight. In this way, the molded meter pit frame systems described herein may be easier to manufacture, ship, carry and install. More specifically, the lighter weight of the molded meter pit frame systems enables them to be manufactured, shipped, carried and installed with, e.g., reduced transportation costs, less manpower, less hoisting or rigging equipment, etc., potentially resulting in savings in costs, safety, and time.

Likewise, unlike cast iron meter pit frame systems, which can be difficult or even impossible to modify or trim in the field should they need to be, the molded meter pit frame systems described herein may enable adjustments to be made more easily. For example, it may be determined during installation of a cast iron meter pit frame that the cast iron does not fit in its current condition, e.g., shape, but can be adjusted in order to make it fit. In this case, the cast iron meter pit frame must be adjusted via heavy duty equipment, e.g., welding or cutting torches, grinding wheels, or the like. Alternatively, it may be determined during installation of a cast iron meter pit frame that the cast iron cannot be adjusted at all (e.g., lack of the necessary heavy-duty equipment), which might require halting installation of the non- or ill-fitting cast iron meter pit frame with a different cast iron meter pit frame that fits better. Either way, adjusting a cast iron meter pit frame may be time-intensive, expensive and potentially more hazardous. In contrast, the molded meter pit frame systems described herein may be more easily adjusted with lighter duty equipment, e.g., blades or other cutting or trimming implements, and may typically be done so on-site and in real-time, again resulting in potential savings in costs, safety, and time.

Still further, unlike cast iron meter pit frame systems, which can tend to rust over time, the molded meter pit frame systems described herein may better retain their appearance by avoiding rusting. This concern may be relevant in any setting, e.g., commercial, industrial, etc., but may be of particular importance in residential settings, where the unsightly appearance of a rusty cast iron meter pit frame systems may be even more noticeable. By avoiding rusting, the molded meter pit frame systems described herein may be more suitable in any such setting, by virtue of its improved appearance over time.

It should also be noted that, while cast iron is often employed because of its strength, the molded meter pit frame systems described herein also have significant strength by virtue of, e.g., their structural features (as will be set forth in additional detail below), rendering them suitable for any setting where exposure to incidental light vehicular traffic is possible, e.g., driveways, sidewalks, etc. Still further, the molded meter pit frame systems described herein are particularly well-suited for non-vehicular settings, e.g., lawns, fields, etc., because settings such as these typically are subjected to lower vehicular loads from passenger vehicles and yard equipment.

While plastic frames are commercially known, these previously employed plastic frames have certain drawbacks. For example, these previously employed plastic frames include ribbing structures that are exposed on the exterior, e.g., top surface, and thus are present above grade when installed. These exposed ribs and structures become trip hazards where installed. Furthermore, exposed ribs and structures are known to be unsightly. While the previous external ribbing designs allow for some improved vertical strength with lesser material, any cost-savings enjoyed in the manufacture of such frames having external ribbing structures are made at the expense of safety and desirability.

In contrast, the meter pit frames described herein are constructed with a generally smooth upper surface and having the rib structures disposed therebeneath. As will be described in additional detail below, the meter pit frame described herein has an advantageous undermounted rib geometry which, along with the amount of rib material and with the generally smooth top surface, provide comparable mechanical performance, e.g., load strength, as compared to the above-described previously-employed externally-ribbed meter pit frames. The generally smooth top surface of the present design has the added benefit of substantially eliminating the trip hazards, obstacles to lawn mowers and weed trimmers, and addresses the commercial desire for a more aesthetically-pleasing utility access point in a customer's yard, driveway, or sidewalk.

For example, in an embodiment, there is provided a meter pit frame that is configured to enclose an opening of a meter pit. The meter pit frame includes an outer frame edge, a circular inner wall defining a central opening from which extends a lip for receiving and supporting a cover, and a plurality of ribs extending between the inner wall and the outer frame edge and configured to enable the meter pit frame to support vertical loading. The meter pit frame is molded from plastic and is configured to enable transmission of data signals therethrough. In embodiments, the cover is supported within the central opening by the lip.

The meter pit frame may also include one or more retention members configured to retain the meter pit frame to a meter pit. The retention members may allow the meter pit frame to fit several different sizes of meter pits, enabling a single such meter pit frame to be used in multiple applications, providing costs savings during manufacturing and to the customer. The plurality of ribs may include a circular rib surrounding the central opening. The meter pit frame may also include a metal locator ring, plate, or plates, configured to be mounted to the body of the meter frame. The metal locator ring may be configured to be detected by a metal detector when the meter pit frame is underground or below grade.

The meter pit frame may also include an expander ring configured to be mounted to the meter pit frame, the expander ring configured to change a meter pit diameter to which the meter pit frame is connectable. The expander ring may be further configured to be mounted to the meter pit. The meter pit frame system may also include an extension component configured to be mounted to the meter pit frame, the extension component configured to extend a distance between a meter pit diameter and the meter pit frame. The meter pit frame may be molded from plastic, e.g., polypropylene, or composite, e.g. glass reinforced polypropylene or resins.

In other embodiments, there is provided a meter pit frame system that includes a molded meter pit frame including an outer frame edge and a circular inner wall defining a lip for receiving and supporting the cover. The molded meter pit frame may also include a plurality of load-bearing ribs extending between the inner wall and the outer frame edge. The system may also include a meter pit configured to contain utility equipment. The meter pit frame may be molded from plastic and may be configured to enable transmission therethrough of data signals to or from the utility equipment.

In embodiments, the molded meter pit frame may also include one or more retention members configured to secure the meter pit frame to the meter pit. The plurality of ribs may include a circular rib surrounding the central opening of the meter pit frame. The meter pit frame system may also include a metal locator ring configured to be mounted to the circular rib. The metal locator ring may be configured to be detected by a metal detector when the meter pit frame is underground.

The meter pit frame system may also include an expander ring configured to be mounted to the meter pit frame, the expander ring configured to change a meter pit diameter to which the meter pit frame is connectable. The expander ring may be further configured to be mounted to the meter pit. The meter pit frame system may also include an extension component configured to be mounted to the meter pit frame, the extension component configured to extend a distance between a meter pit diameter and the meter pit frame. The meter pit frame may be molded from plastic, e.g., polypropylene, or composite, e.g. glass reinforced polypropylene or resins.

### DRAWINGS

FIG. 1A shows a top view of a molded meter pit frame, in accordance with various embodiments.

FIG. 1B shows a side view of the molded meter pit frame, in accordance with various embodiments.

FIG. 1C shows a bottom view of the molded meter pit frame, in accordance with various embodiments.

FIG. 1D shows a top perspective view of a molded meter pit frame, in accordance with various embodiments.

FIG. 1E shows a bottom perspective view of the molded meter pit frame, in accordance with various embodiments.

FIG. 1F shows a side cross-sectional view of the molded meter pit frame taken along section F-F shown in FIG. 1A, in accordance with various embodiments.

FIG. 1G shows a detailed view B taken from the side cross-sectional view of FIG. 1F, in accordance with various embodiments.

FIG. 2A shows a side cross-sectional view of a molded meter pit frame, similar to that taken along section F-F shown in FIG. 1A but for a thinner lid, in accordance with various embodiments.

FIG. 2B shows a detailed view C taken from the bottom view of FIG. 1C, in accordance with various embodiments.

FIG. 3A is a detailed view A taken from the side cross-sectional view of FIG. 1F, showing various retention members, in accordance with various embodiments.

FIG. 3B is a detailed view of an alternative design of retention members, in accordance with various embodiments.

FIG. 4A shows a top view of a molded meter pit frame having a metal locator ring installed thereon, in accordance with various embodiments.

FIG. 4B shows a side view of the molded meter pit frame, in accordance with various embodiments.

FIG. 4C shows a bottom view of the molded meter pit frame, in accordance with various embodiments.

FIG. 4D shows a side cross-sectional view of the molded meter pit frame taken along section D-D shown in FIG. 4B, in accordance with various embodiments.

FIG. 4E shows a bottom perspective view of the molded meter pit frame, in accordance with various embodiments.

FIG. 4F shows a detailed view F taken from the bottom view of FIG. 4C, in accordance with various embodiments.

FIG. 5A shows a top perspective view of a molded meter pit frame mounted on a bullet nose-type meter pit, in accordance with various embodiments.

FIG. 5B shows a top view of the molded meter pit frame mounted on the bullet nose-type meter pit, in accordance with various embodiments.

FIG. 5C shows a side view of the molded meter pit frame mounted on the bullet nose-type meter pit, in accordance with various embodiments.

FIG. 5D shows a side cross-sectional view of the molded meter pit frame mounted on the bullet nose-type meter pit, taken along section D-D shown in FIG. 5C, in accordance with various embodiments.

FIG. 6A shows a top perspective view of a molded meter pit frame mounted on a straight wall-type meter pit, in accordance with various embodiments.

FIG. 6B shows a top view of the molded meter pit frame mounted on the straight wall-type meter pit, in accordance with various embodiments.

FIG. 6C shows a side view of the molded meter pit frame mounted on the straight wall-type meter pit, in accordance with various embodiments.

FIG. 6D shows a side cross-sectional view of the molded meter pit frame mounted on the straight wall-type meter pit, taken along section D-D shown in FIG. 6C, in accordance with various embodiments.

FIG. 7A shows a top perspective view of a molded meter pit frame mounted on a straight wall-type meter pit and having an expander ring disposed therebetween, in accordance with various embodiments.

FIG. 7B shows a top view of the molded meter pit frame mounted on the straight wall-type meter pit and having an expander ring disposed therebetween, in accordance with various embodiments.

FIG. 7C shows a side view of the molded meter pit frame mounted on the straight wall-type meter pit and having an expander ring disposed therebetween, in accordance with various embodiments.

FIG. 7D shows a side cross-sectional view of the molded meter pit frame mounted on the straight wall-type meter pit and having an expander ring disposed therebetween, taken along section D-D shown in FIG. 7C, in accordance with various embodiments.

FIG. 8A shows a top perspective view of a molded meter pit frame mounted on a straight wall-type meter pit and having a bullet-nose extension piece disposed therebetween, in accordance with various embodiments.

FIG. 8B shows a side view of the molded meter pit frame mounted on the straight wall-type meter pit and having a bullet-nose extension piece disposed therebetween, in accordance with various embodiments.

FIG. 8C shows a side cross-sectional view of the molded meter pit frame mounted on the straight wall-type meter pit and having a bullet-nose extension piece disposed therebetween, taken along section C-C shown in FIG. 8B, in accordance with various embodiments.

### DETAILED DESCRIPTION

Reference will now be made in detail to specific embodiments illustrated in the accompanying drawings. In the following detailed description, numerous specific details are set forth to provide a thorough understanding. However, it will be apparent to one of ordinary skill in the art that embodiments may be practiced without these specific details. In other instances, known methods, procedures and/or components have not been described in detail so as not to unnecessarily obscure aspects of the embodiments.

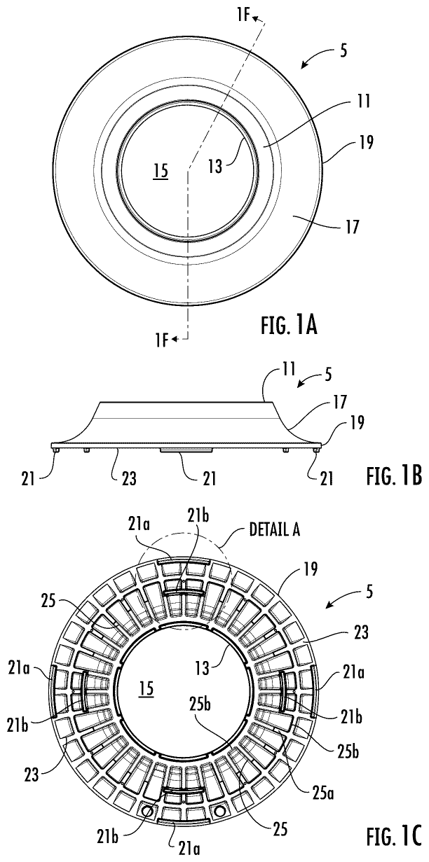

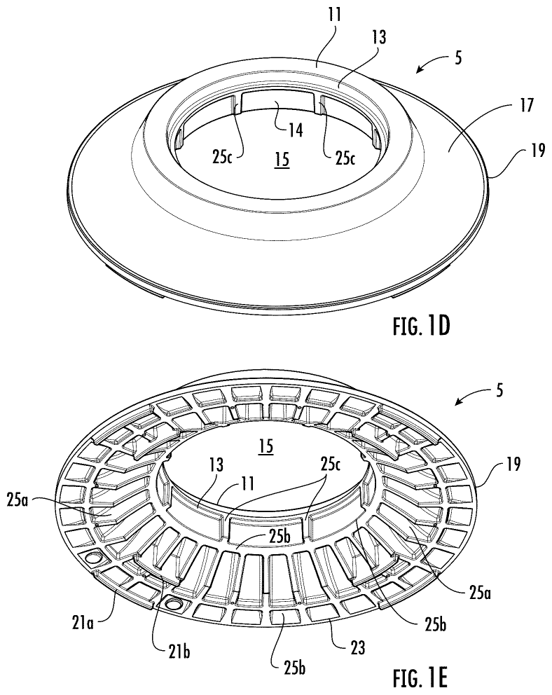

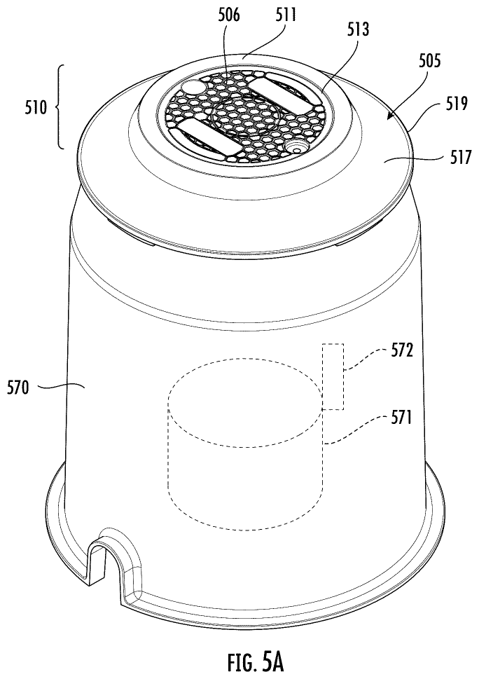

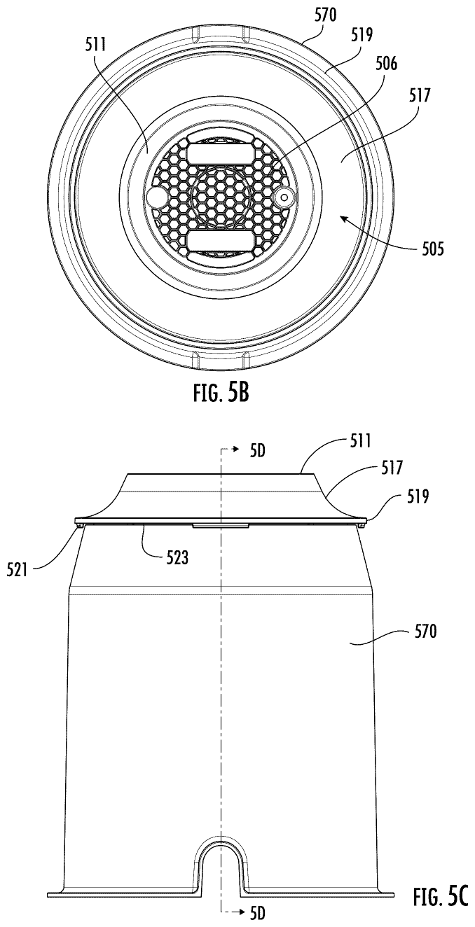

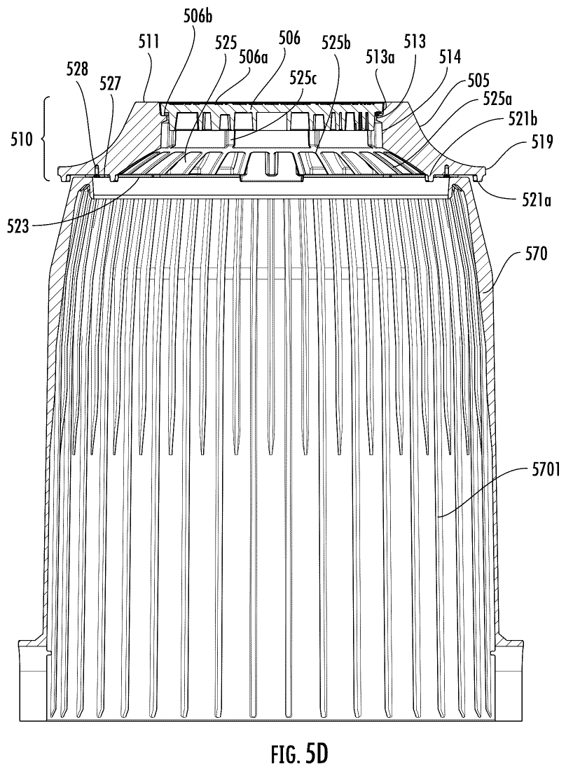

As set forth above, FIG. 1A is a top view of a molded meter pit frame, in accordance with various embodiments. More specifically, FIG. 1A shows a top view of molded meter pit frame 5. The molded meter pit frame 5 is configured to be assembled with a cover, the molded meter pit frame 5 and cover together forming a lid for a meter pit. Although only the molded meter pit frame 5 is shown in FIGS. 1A, the other components are shown, for example, in FIG. 5A, which is described in further detail below. Referring to FIG. 1A, it is shown that the molder meter pit frame 5 may include an upper ring surface 11 onto which may be molded various customizable logos or symbols. Located radially within the upper ring surface 11 is an inner lip 13, configured to receive and support a cover, as will be further described and shown below. The upper ring surface 11 and the inner lip 13 are shown as circular, but may comprise other shapes too. Also, the upper ring surface 11 and the inner lip 13 collectively define a central opening 15 which is shown as open in this view and which may, when installed, provide access to a user to the equipment and/or instrumentation within the meter pit. Also shown in FIG. 1A is an upper frame surface 17, which extends radially outwards from the upper ring surface 11 to a radially outer frame edge 19.

Referring now to FIG. 1B, there is shown a side view of this embodiment of the molded meter pit frame 5. The upper frame surface 17 is shown in this embodiment as sloping downwardly as it extends radially outwards from the upper ring surface 11 to a radially outer frame edge 19. Various slopes or geometries of the upper frame surface 17 are envisioned, depending on the application for which the molded meter pit frame 5 is used. Advantageously, the downward slope of upper frame surface 17 enables the molded meter pit frame 5 to have a minimal profile above the outer edge 19, regardless of whether the molded meter pit frame 5 is buried only up to the height of the outer edge 19 or whether its completely buried up to the height of the upper ring surface 11. Having the upper frame surface 17 being relatively smooth, while having the rib structures (shown and described in further detail below) may help enable the molded meter pit frame 5 to improve its safety (e.g., less tripping hazard etc) as well as its outward appearance. For example, the sloped upper frame surface 17, having the geometry shown, advantageously transfers vertical loads from the meter pit frame, for example its cover and/or cover seating structure, out to the meter pit (which is typically able to bear high vertical loads). The sloped upper frame surface 17, having the geometry shown, also provides for a substantially lesser amount of material exposed at or above grade where it is exposed. When previously-employed meter pit frames, having upwardly-extending, exposed rib structures are installed, these ribs are exposed at grade and create trip hazards, hazards to lawn mowers and string trimmers, and are unsightly. In contrast, the present meter pit frame have a generally smooth upper surface geometry that drops away, e.g., slopes downwardly, aggressively and transitions to the outer edge 19 thereof such that the upper surface extends in a generally horizontal direction as it approaches the outer edge 19. This relatively tall rib structure (described further below) in the radially-inner sections of the meter pit frame may improve the transfer of vertical loads outwardly (to the meter pit). FIG. 1B also illustrates the molded meter pit frame 5 as having retention members 21 extending downwardly from a lower surface 23 thereof. In various embodiments, the retention members 21 configured to help position and secure the molded meter pit frame 5 to various structures, e.g., a meter pit and/or a meter pit expander ring or extension piece (which are shown and described in additional embodiments below).

Referring now to FIG. 1C, there is shown a bottom view of the molded meter pit frame 5, in accordance with this embodiment. FIG. 1C shows that, on the underside of the upper frame surface 17, are various rib structures 25 (only some of which are labelled so as not to obscure the view). The various rib structures 25 may include radially-extending ribs 25a that extend between the inner lip 13 and the outer frame edge 19. The various rib structures 25 may also include ring-shaped ribs 25b that extend, e.g., circularly, around the central opening 15 at various circumferential positions between the circular inner lip 13 and the circular outer frame edge 19. The retention members 21 may also be configured along the rib structures 25, with certain retention member 21a located circumferentially along the outer frame edge 19 and others, such as retention members 21b, being located radially inwardly therefrom.

Referring now to FIG. 1D, there is shown a top perspective view of the molded meter pit frame, in accordance with this embodiment. In this view, there is shown that the molded meter pit 5 also has a vertical wall 14 which extends downwardly from the inner lip 13. Disposed on the vertical wall 14 are vertical ribs 25c that provide additional stiffening and support to the molded meter pit frame 5.

Referring now to FIG. 1E, there is shown a bottom perspective view of the molded meter pit frame 5, in accordance with this embodiment. This view illustrates the vertical ribs 25c connected on one end to the inner lip 13 and on its other end to one of the ring-shaped ribs 25b, in this case the ring-shaped rib 25b that extends circularly around the central opening 15. FIG. 1E also shows the radially-extending ribs 25a extending at least partially from the lower frame surface 23 to the upper frame surface 11. In this way, the molded meter pit frame 5 provides additional structural integrity when subjected to vertical loads. The rib structure 25 also enables the molded meter pit frame 5 to be relatively lightweight, ensuring its ease of transport, handling and installation.

Of course, it should be recognized that the molded meter pit frame, according to various embodiments, may be configured to fit with covers having a variety of different of different sizes, shapes, thicknesses, etc. For example, FIG. 1F is a side cross-sectional view of the molded meter pit frame taken along section F-F shown in FIG. 1A, with FIG. 1G showing additional details thereof. In this embodiment, and as shown in FIGS. 1F and 1G, the molded meter pit frame 5 is shown having a relatively long radially-inner sidewall 13a between the upper surface 11 and the inner lip 13. This provides space for a relatively thicker cover to be placed into the central opening 15 and for the bottom surface of such a cover to sit against the inner lip 13 with the top surface of such a cover sitting flush with, e.g., without the top of the cover sitting proud of, the upper surface 11.

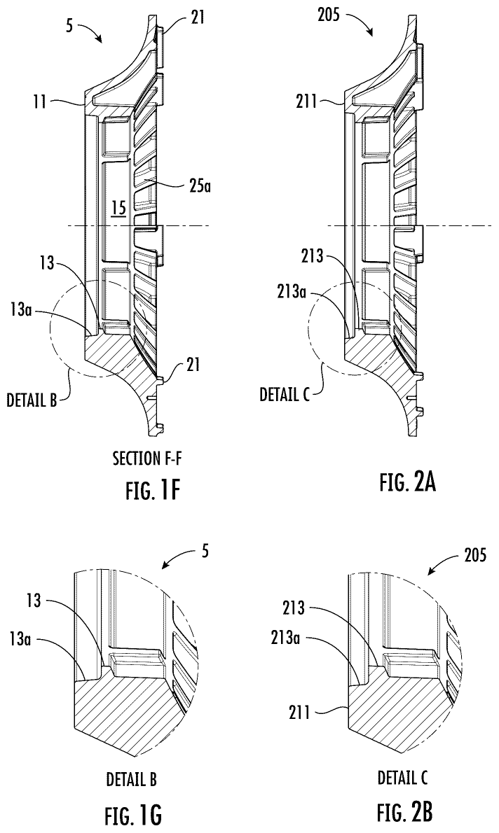

As set forth above, the molded meter pit frame, according to various embodiments, may also be configured to fit with thinner covers. For example, FIG. 2A is a side cross-sectional view of a molded meter pit frame 205, similar to that shown in FIG. 1F and showing a section similar to that taken along section F-F of FIG. 1A. FIG. 2B shows additional details of the cross-sectional view of FIG. 2A. In the embodiment shown in FIGS. 2A and 2B, the molded meter pit frame 205 is shown having a relatively shorter radially-inner sidewall 213a between the upper surface 211 and the inner lip 213. This provides space for a relatively thinner cover to be placed into the central opening 15 and for the bottom surface of such a cover to sit against the inner lip 213 with the top surface of such a cover sitting flush with, e.g., without the top of the cover sitting proud of, the upper surface 211. Of course, other sizes and shapes are also contemplated.

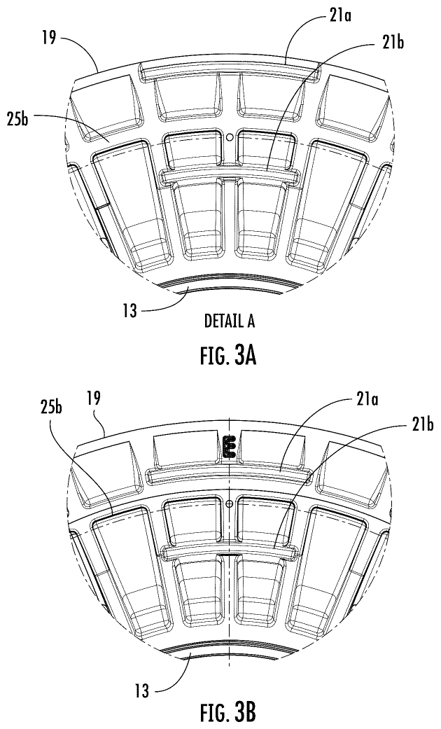

As set forth above, it should be recognized that the molded meter pit frame, according to various embodiments, may be configured with retention members that enable the molded meter pit frame to be connected with meter pits (or other intervening structures) having a variety of different of different sizes, shapes, and/or connecting mechanisms. For example, FIG. 3A is a detailed view A taken from the side cross-sectional view of FIG. 1F, showing retention members 21a and 21b in a first configuration. Specifically, in this arrangement, which may be suitable for a first meter pit size, retention member 21a is positioned along the outer circumference of the outer frame edge 19, while the retention member 21b is positioned radially between a ring-shaped rib 25b and the inner lip 13. In contrast, in the embodiment shown in FIG. 3B, which may be suitable for a second meter pit size, retention member 21a is positioned along the ring-shaped rib 25b, while the retention member 21b is positioned radially between the ring-shaped rib 25b and the inner lip 13. Of course, other arrangements of the retention members 25 are also contemplated.

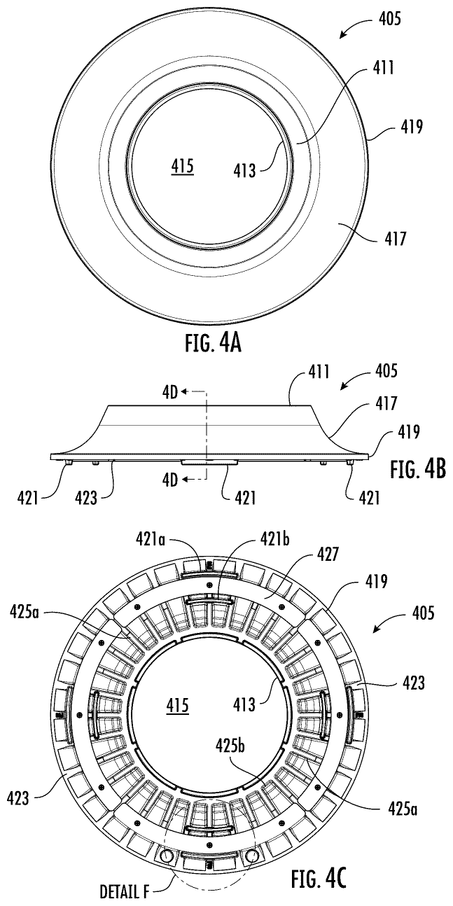

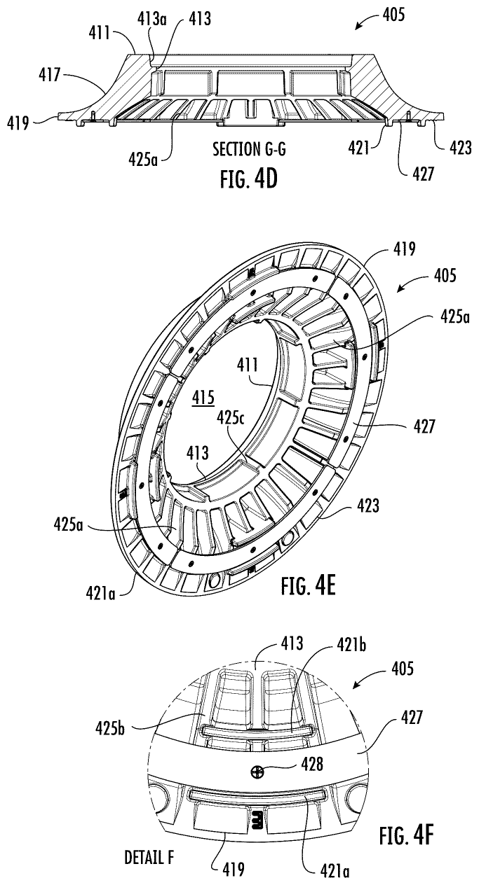

As set forth above, the molded meter pit frame described herein may typically be employed underground. As such, it may occur that the molded meter pit frame is, in use, covered by dirt, sand, lawn or other materials. Being covered in this way, there may be occasions when the molded meter pit frame is difficult to locate in the field. In order to assist with the molded meter pit frame being located, the molded meter pit frame may be equipped with additional structures. For example, FIGS. 4A-4F show various views of a molded meter pit frame 405 having a metal locator ring 427 installed thereon, in accordance with various embodiments. FIG. 4A is a top view of same. Like the previously-described embodiments, the molded meter pit frame 405 is configured to be assembled with a cover, the molded meter pit frame 405 and cover together forming a lid for a meter pit. Although only the molded meter pit frame 405 is shown in FIGS. 4A, the other components are shown, for example, in FIG. 5A, which is described in further detail below. Referring to FIG. 4A, it is shown that the molder meter pit frame 405 may include an upper ring surface 411 onto which may be molded various customizable logos or symbols. Located radially within the upper ring surface 411 is an inner lip 413, configured to receive and support a cover, as will be further described and shown below. The upper ring surface 411 and the inner lip 413 are shown as circular, but may comprise other shapes too. Also, the upper ring surface 411 and the inner lip 413 collectively define a central opening 415 which is shown as open in this view and which may, when installed, provide access to a user to the equipment and/or instrumentation within the meter pit. Also shown in FIG. 4A is an upper frame surface 417, which extends radially outwards from the upper ring surface 411 to a radially outer frame edge 419.

Referring now to FIG. 4B, there is shown a side view of this embodiment of the molded meter pit frame 405. The upper frame surface 417 is again shown in this embodiment as sloping downwardly as it extends radially outwards from the upper ring surface 411 to a radially outer frame edge 419. Various slopes or geometries of the upper frame surface 417 are envisioned, depending on the application for which the molded meter pit frame 405 is used. FIG. 4B also illustrates the molded meter pit frame 405 as having retention members 421 extending downwardly from a lower surface 423 thereof. In various embodiments, the retention members 421 are configured to help position and secure the molded meter pit frame 405 to various structures, e.g., a meter pit and/or a meter pit expander ring or extension piece (which are shown and described in additional embodiments below).

Referring now to FIG. 4C, there is shown a bottom view of the molded meter pit frame 405, in accordance with this embodiment. FIG. 4C shows that, on the underside of the upper frame surface 417, are various rib structures 425 (only some of which are labelled so as not to obscure the view). The various rib structures 425 may, like the embodiment previously described, include radially-extending ribs 425a that extend between the inner lip 413 and the outer frame edge 419. The various rib structures 425 may also include ring-shaped ribs 425b that extend, e.g., circularly, around the central opening 415 at various circumferential positions between the circular inner lip 413 and the circular outer frame edge 419. The retention members 421 may also be configured along the rib structures 425, with certain retention member 421a located circumferentially along the outer frame edge 419 and others, such as retention members 421b, being located radially inwardly therefrom. Situated radially between the retention members 421a and 421b is secured a metal locator ring 427. The metal locator ring 427 can be employed such that a metal detector can better locate the molded meter pit frame 405 when it has been covered or buried with other materials, e.g., turf, mulch, gravel, etc. While a ring is shown, other configurations of metal components attached to the molded meter pit frame disclosed herein.

Referring now to FIG. 4D, there is shown a side cross-sectional view of the molded meter pit frame 405 taken along section D-D shown in FIG. 4B, in accordance with various embodiments. In this embodiment, and as shown in FIG. 4D, the molded meter pit frame 405 has a radially-inner sidewall 413a between the upper surface 411 and the inner lip 413. This provides space for a cover (not shown) to be placed into the central opening 415 and for the bottom surface of such a cover to sit against the inner lip 413 with the top surface of such a cover sitting flush with, e.g., without the top of the cover sitting proud of, the upper surface 411.

Referring to FIG. 4E, there is shown a bottom perspective view of the molded meter pit frame, in accordance with various embodiments. This view illustrates the vertical ribs 425c connected on one end to the inner lip 413 and on its other end to one of the ring-shaped ribs 425b, in this case the ring-shaped rib 425b that extends circularly around the central opening 415. FIG. 4E also shows the radially-extending ribs 425a extending at least partially from the lower frame surface 423 to the upper frame surface 411. In this way, the molded meter pit frame 405 provides additional structural integrity when subjected to vertical loads. The rib structure 425 also enables the molded meter pit frame 405 to be relatively lightweight, ensuring its ease of transport, handling and installation.

Referring to FIG. 4F, there is shown a detailed view F taken from the bottom view of FIG. 4C, in accordance with various embodiments. FIG. 4F shows the retention members 421a and 421b in a configuration suitable for a first meter pit size, the retention member 421a is positioned along the ring-shaped rib 425b, while the retention member 421b is positioned radially between the ring-shaped rib 425b and the inner lip 413. Secured radially between the retention members 421a and 421b is the metal locator ring 427 which, as set forth above, can enable a metal detector to better locate the molded meter pit frame 405 when it has been covered or buried. Various mechanisms can be employed to secure the metal locator ring 427 to the molded meter pit frame 405. In the example shown, the metal locator ring 427 is secured to the molded meter pit frame 405 by various screws 428 positioned at intermittent positions along the circumference of the metal locator ring 427.

As set forth above, the molded meter pit frames described herein are configured to be assembled with a cover, the molded meter pit frame and cover together forming a lid for a meter pit. FIG. 5A shows a top perspective view of a molded meter pit frame mounted on a bullet nose-type meter pit, in accordance with various embodiments. More specifically, FIG. 5A illustrates a molded meter pit frame 505 assembled with a cover 506, the molded meter pit frame 505 and cover 506 together forming a lid 510 for a bullet-nose meter pit 570. Also shown in FIG. 5A is a schematic representation of a utility instrument 571 (shown in dotted line because the instrument 571 is located within the meter pit 570). Also shown in FIG. 5A is a schematic representation of an antenna 572 (also shown in dotted line because the antenna 572 is located within the meter pit 570). Of course, it should be appreciated that the meter pit 570 may have any type of utility equipment or instrumentation 571 disposed therein, and the antenna 572 may be any type of communication and/or data-transmitting and/or receiving antenna therein, and that this figure is provided to show a simplified example only of such a meter pit 570. Any type of meter pit 570, utilized for housing any conceivable instrument 571 and/or antenna 572 having any conceivable purpose, is envisioned herein. The other components shown in FIG. 5A are described in further detail below.

Still referring to FIG. 5A, the molded meter pit frame 505 includes an upper ring surface 511 onto which may be molded various customizable logos or symbols. Located radially within the upper ring surface 511 is an inner lip 513 (partially obscured by the cover 506), configured to receive and support the cover 506. The upper ring surface 511 and the inner lip 513 are shown as circular, but may comprise other shapes too. Also, the upper ring surface 511 and the inner lip 513 collectively define a central opening which houses the cover 506 and which may, upon removal of the cover 506, provide access to a user to the equipment and/or instrumentation within the meter pit 570. Also shown in FIG. 5A is an upper frame surface 517, which extends radially outwards from the upper ring surface 511 to a radially outer frame edge 519.

Referring to FIG. 5B, there is shown a top view of the molded meter pit frame 505 mounted on the bullet nose-type meter pit 570, in accordance with various embodiments. FIG. 5C, on the other hand, shows a side view of the molded meter pit frame 505 mounted on the bullet nose-type meter pit 570, in accordance with various embodiments. The upper frame surface 517 is again shown in this embodiment as sloping downwardly as it extends radially outwards from the upper ring surface 511 to a radially outer frame edge 519, although other slopes and/or geometries of the upper frame surface 517 are envisioned. FIG. 5C also illustrates the molded meter pit frame 505 as having retention members 521 extending downwardly from a lower surface 523 thereof. As described above, the retention members 521 may be configured to help position and secure the molded meter pit frame 505 to various structures, in this case the meter pit 570.

FIG. 5D shows a side cross-sectional view of the molded meter pit frame 505 mounted on the bullet nose-type meter pit 570, taken along section D-D shown in FIG. 5C, in accordance with various embodiments. FIG. 5D shows that, on the underside of the upper frame surface 517, are various rib structures 525 (only some of which are labelled so as not to obscure the view). The various rib structures 525 may include radially-extending ribs 525a that extend between the inner lip 513 and the outer frame edge 519. The various rib structures 525 may also include ring-shaped ribs 525b that extend, e.g., circularly, around the central opening at various circumferential positions between the circular inner lip 513 and the circular outer frame edge 519. Retention members 521 may also be configured along the rib structures 525, with certain retention member 521a located circumferentially along the outer frame edge 519 and others, such as retention members 521b, being located radially inwardly therefrom.

Still referring to FIG. 5D, the molded meter pit frame 505 may also have a vertical wall 514 which extends downwardly from the inner lip 513. Disposed on the vertical wall 514 are vertical ribs 525c that provide additional stiffening and support to the molded meter pit frame 505, the vertical ribs 525c connected on one end to the inner lip 513 and on its other end to one of the ring-shaped ribs 525b, in this case the ring-shaped rib 525b that extends circularly around the central opening. FIG. 5D also shows the radially-extending ribs 525a extending at least partially from the lower frame surface 523 to the upper frame surface 511 to provide additional structural integrity and enabling the molded meter pit frame 505 to be relatively lightweight. The molded meter pit frame 505 also has a radially-inner sidewall 513a between the upper surface 511 and the inner lip 513 that allows the bottom surface 506b of the cover 506 to sit against the inner lip 513 with the top surface 506a of the cover 506 sitting flush with the upper surface 511 of the molded meter pit frame 505. FIG. 5D also shows the metal locator ring 527 secured to the bottom surface 523 of the molded meter pit 505 via attachment screws 528. FIG. 5D also shows the meter pit 570 having ribs 5701 for providing additional structural integrity thereto.

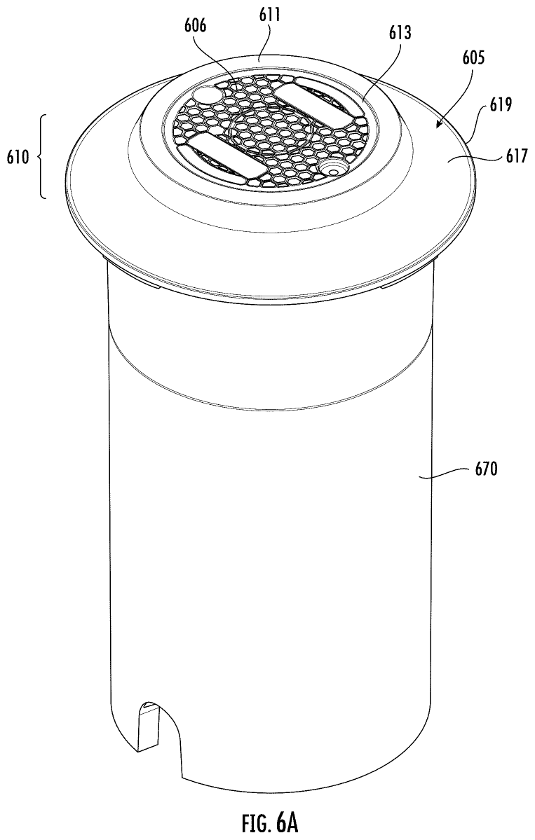

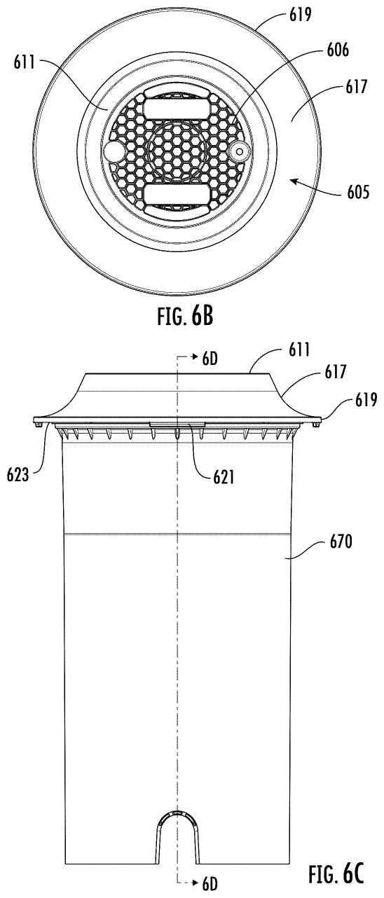

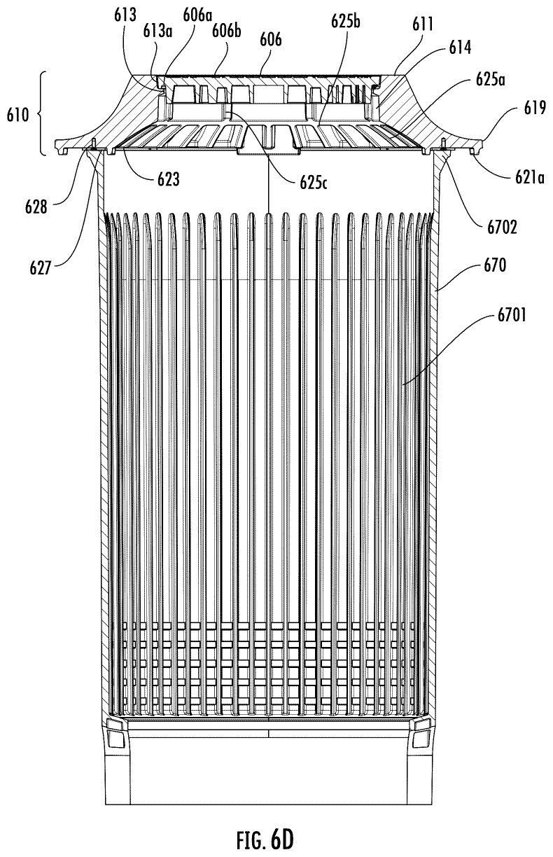

As set forth above, the molded meter pit frames described herein are configured, along with the cover with which they together form a lid, to be sized and configured for use with various sizes and shapes of meter pits. For example, FIG. 6A shows a top perspective view of a molded meter pit frame 605 mounted on a straight wall-type meter pit 670, in accordance with various embodiments. More specifically, FIG. 6A illustrates a molded meter pit frame 605 assembled with a cover 606, the molded meter pit frame 605 and a cover 606 together forming a lid 610 for the straight wall-type meter pit 670. The straight wall-type meter pit 670 may be configured to house, e.g., a utility instrument (not shown here but similar to that shown in FIG. 5A as the instrument 571), and/or an antenna (also not shown here, but similar to that shown in FIG. 5A as antenna 572). As above, it should be appreciated that the straight wall-type meter pit 670 may have any type of utility equipment or instrumentation disposed therein, and the antenna may be any type of communication and/or data-transmitting and/or receiving antenna therein, and that this figure is provided to show a simplified example only of such a straight wall-type meter pit 670. Any type of meter pit 670, utilized for housing any conceivable instrument and/or antenna having any conceivable purpose, is envisioned herein. The other components shown in FIG. 6A are described in further detail below.

Still referring to FIG. 6A, the molded meter pit frame 605 includes an upper ring surface 611 onto which may be molded various customizable logos or symbols. Located radially within the upper ring surface 611 is an inner lip 613 (partially obscured by the cover 606), configured to receive and support the cover 606. The upper ring surface 611 and the inner lip 613 are shown as circular, but may comprise other shapes too. Also, the upper ring surface 611 and the inner lip 613 collectively define a central opening which houses the cover 606 and which may, upon removal of the cover 606, provide access to a user to the equipment and/or instrumentation within the meter pit 670. Also shown in FIG. 6A is an upper frame surface 617, which extends radially outwards from the upper ring surface 611 to a radially outer frame edge 619.

Referring to FIG. 6B, there is shown a top view of the molded meter pit frame 605 mounted on the straight wall-type meter pit 670, in accordance with various embodiments. FIG. 6C, on the other hand, shows a side view of the molded meter pit frame 605 mounted on the straight wall-type meter pit 670, in accordance with various embodiments. The upper frame surface 617 s slopes downwardly as it extends radially outwards from the upper ring surface 611 to a radially outer frame edge 619, although other slopes and/or geometries of the upper frame surface 617 are envisioned. FIG. 6C also illustrates the molded meter pit frame 605 as having retention members 621 extending downwardly from a lower surface 623 thereof. As described above, the retention members 621 may be configured to help position and secure the molded meter pit frame 605 to various structures, in this case the meter pit 670.

FIG. 6D shows a side cross-sectional view of the molded meter pit frame 605 mounted on the straight wall-type meter pit 670, taken along section D-D shown in FIG. 6C, in accordance with various embodiments. FIG. 6D shows that, on the underside of the upper frame surface 617, are various rib structures 625 that may include radially-extending ribs 625a that extend between the inner lip 613 and the outer frame edge 619 and ring-shaped ribs 625b that extend circularly around the central opening at various circumferential positions between the circular inner lip 613 and the circular outer frame edge 619. Retention members 621 may also be configured along the rib structures 625, with certain retention member 621a located circumferentially along the outer frame edge 619 and others, such as retention members 621b, being located radially inwardly therefrom.

Still referring to FIG. 6D, the molded meter pit frame 605 may also have a vertical wall 614 which extends downwardly from the inner lip 613. Disposed on the vertical wall 614 are vertical ribs 625c that provide additional stiffening and support to the molded meter pit frame 605, the vertical ribs 625c connected on one end to the inner lip 613 and on the other end to one of the ring-shaped rib 625b that extends circularly around the central opening. FIG. 6D also shows the radially-extending ribs 625a extending at least partially from the lower frame surface 623 to the upper frame surface 611 to provide additional structural integrity and enabling the molded meter pit frame 605 to be relatively lightweight. The molded meter pit frame 605 also has a radially-inner sidewall 613a between the upper surface 611 and the inner lip 613 that allows the bottom surface 606b of the cover 606 to sit against the inner lip 613 with the top surface 606a of the cover 606 sitting flush with the upper surface 611 of the molded meter pit frame 605. FIG. 6D also shows the metal locator ring 627 secured to the bottom surface 623 of the molded meter pit 605 via attachment screws 628. In this embodiment, the upper edge 6702 of the straight wall-type meter pit 670 is aligned with the metal locator ring 627 allow attachment directly thereto, if desired. FIG. 6D also shows the meter pit 670 having ribs 6701 for providing additional structural integrity.

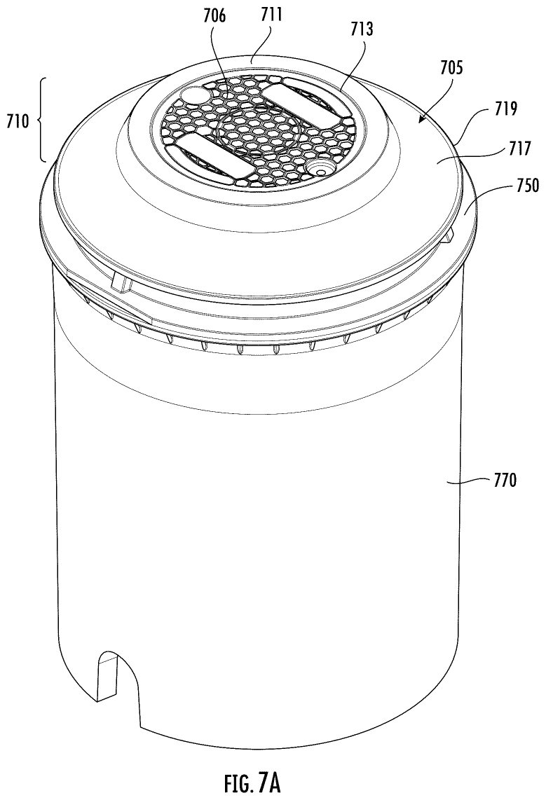

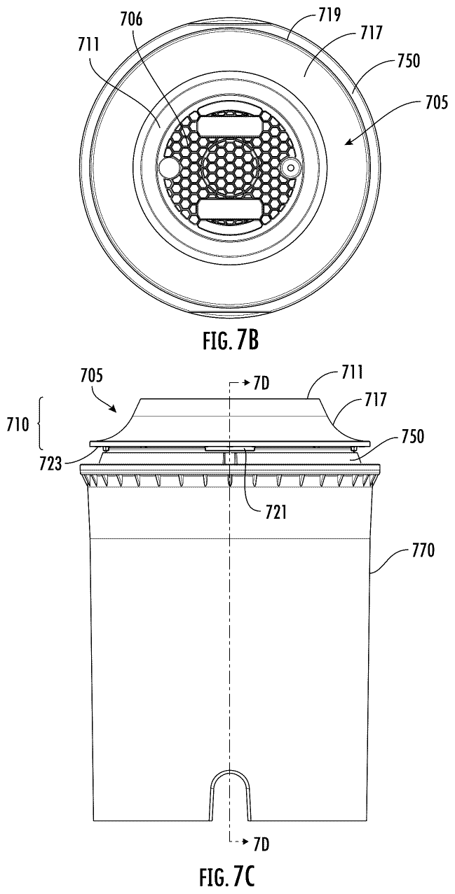

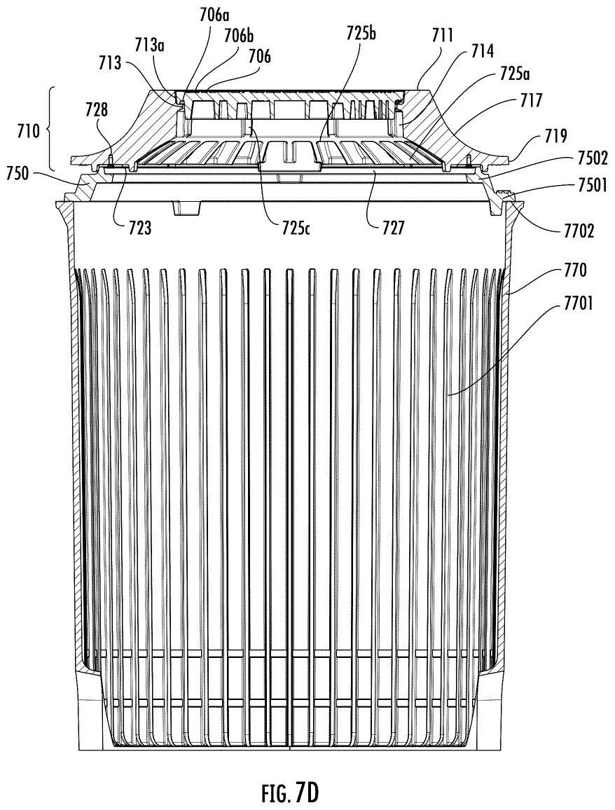

Still further, the molded meter pit frames described herein may be configured, along with the cover with which they together form a lid, to be sized and configured for use with additional components, e.g., expander and/or extension components, for enabling them to couple to different sizes and shapes of meter pits. For example, FIG. 7A shows a top perspective view of a molded meter pit frame mounted on a straight wall-type meter pit and having an expander ring disposed therebetween, in accordance with various embodiments. More specifically, FIG. 7A illustrates a molded meter pit frame 705 assembled with a cover 706, the molded meter pit frame 705 and a cover 706 together forming a lid 710 for the straight wall-type meter pit 770, there being an expender ring 750 disposed therebetween. As set forth above, the straight wall-type meter pit 770 may be configured to house, e.g., a utility instrument (not shown here but similar to that shown in FIG. 5A as the instrument 571), and/or an antenna (also not shown here, but similar to that shown in FIG. 5A as antenna 572). As above, it should be appreciated that the straight wall-type meter pit 770 may have any type of utility equipment or instrumentation disposed therein, and the antenna may be any type of communication and/or data-transmitting and/or receiving antenna therein.

Still referring to FIG. 7A, the molded meter pit frame 705 includes an upper ring surface 711 onto which may be molded various customizable logos or symbols. Located radially within the upper ring surface 711 is an inner lip 713 (obscured by the cover 706), configured to receive and support the cover 706. The upper ring surface 711 and the inner lip 713 collectively define a central opening which houses the cover 706 and which may, upon removal of the cover 706, provide access to a user to the equipment and/or instrumentation within the meter pit 770. The upper frame surface 717 extends radially outwards from the upper ring surface 711 to a radially outer frame edge 719.

FIG. 7B shows a top view (while FIG. 7C shows a side view) of the molded meter pit frame 705 mounted on the straight wall-type meter pit 770 and having the expander ring 750 disposed therebetween, in accordance with various embodiments. The upper frame surface 717 slopes downwardly as it extends radially outwards from the upper ring surface 711 to a radially outer frame edge 719, other slopes and/or geometries of the upper frame surface 617 also being contemplated. FIG. 7C illustrates the molded meter pit frame 705 as having retention members 721 extending downwardly from a lower surface 723 thereof, the retention members 721 configured to help position and secure the molded meter pit frame 705 to various structures, in this case the expander ring 750.

FIG. 7D shows a side cross-sectional view of the molded meter pit frame 705 mounted on the straight wall-type meter pit 770 and having the expander ring 750 disposed therebetween, taken along section D-D shown in FIG. 7C, in accordance with various embodiments. FIG. 7D shows that, on the underside of the upper frame surface 717, are various rib structures 725 that may include radially-extending ribs 725a that extend between the inner lip 713 and the outer frame edge 719 and ring-shaped ribs 725b that extend circularly around the central opening at various circumferential positions between the circular inner lip 713 and the circular outer frame edge 719. Retention members 721 may also be configured along the rib structures 725, with certain retention member 721a located circumferentially along the outer frame edge 719 and others, such as retention members 721b, being located radially inwardly therefrom.

Still referring to FIG. 7D, the molded meter pit frame 705 may also have a vertical wall 714 which extends downwardly from the inner lip 713. Disposed on the vertical wall 714 are vertical ribs 725c that provide additional stiffening and support to the molded meter pit frame 705, the vertical ribs 725c connected on one end to the inner lip 713 and on the other end to one of the ring-shaped rib 725b that extends circularly around the central opening. FIG. 7D shows the radially-extending ribs 725a extending at least partially from the lower frame surface 723 to the upper frame surface 711 to provide additional structural integrity and enabling the molded meter pit frame 705 to be relatively lightweight. The molded meter pit frame 705 also has a radially-inner sidewall 713a between the upper surface 711 and the inner lip 713 that allows the bottom surface 706b of the cover 706 to sit against the inner lip 713 with the top surface 706a of the cover 706 sitting flush with the upper surface 711 of the molded meter pit frame 705.

FIG. 7D also shows the metal locator ring 727 secured to the bottom surface 723 of the molded meter pit 705 via attachment screws 728. In this embodiment, the upper edge 7702 of the straight wall-type meter pit 770 is aligned with and sits against a lip 7501 of the expander ring 750, while an upper lip 7502 of the expander ring 750 is aligned with and sits against the bottom surface 723 of the molded meter pit frame 705. The expander ring 750 may be dimensioned so as to enable any size molded meter pit frame 705 to attach to and/or seal with any size meter pit 770. FIG. 7D also shows the meter pit 770 having ribs 7701 for providing additional structural integrity.

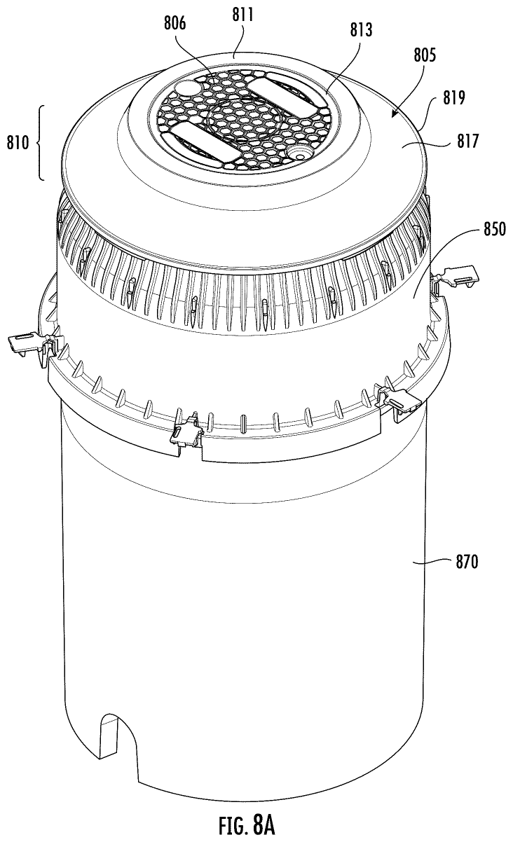

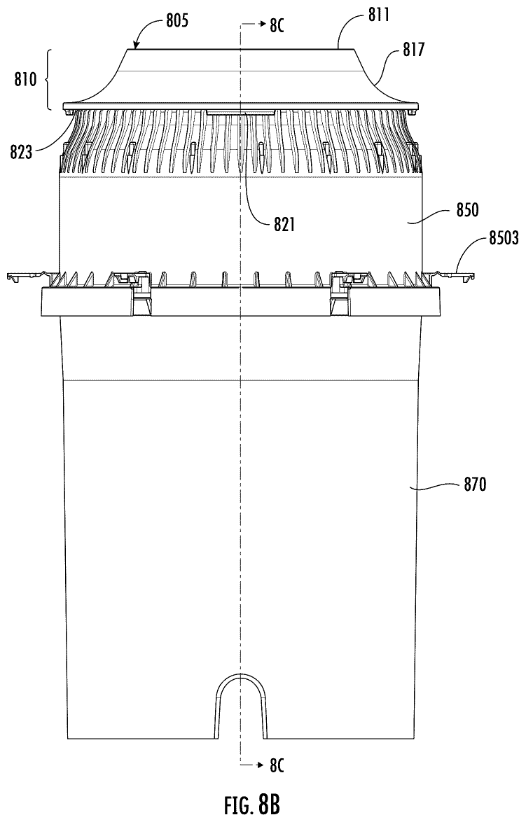

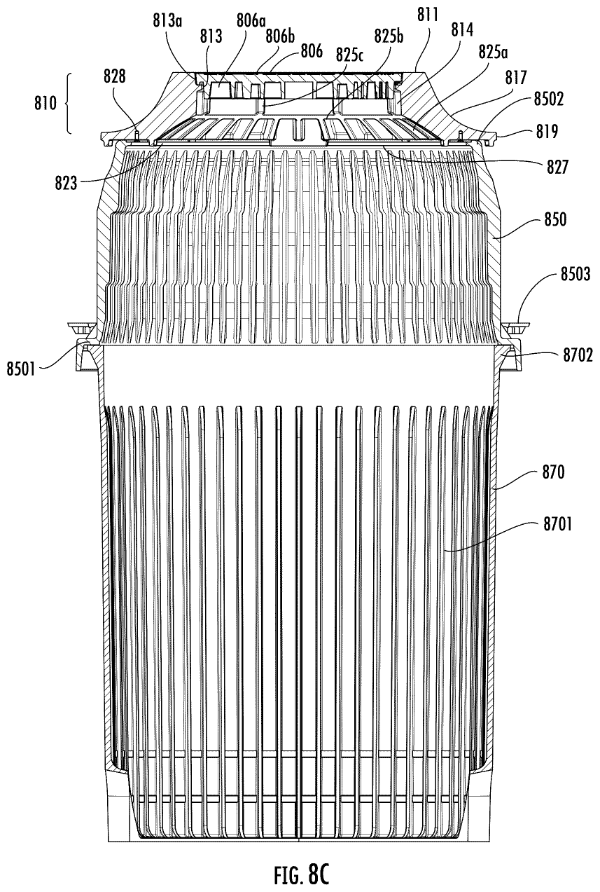

Of course, other components can also be employed with the molded meter pit frames described herein. For example, FIG. 8A shows a top perspective view of a molded meter pit frame 805 mounted on a straight wall-type meter pit 870 and having a bullet-nose extension piece 850 disposed therebetween, in accordance with various embodiments. More specifically, FIG. 8A illustrates a molded meter pit frame 805 assembled with a cover 806, the molded meter pit frame 805 and the cover 806 together forming a lid 810 for the straight wall-type meter pit 870, there being a bullet-nose extension component 850 disposed therebetween. As set forth above, the straight wall-type meter pit 870 may be configured to house any type of utility instrument and/or any type of antenna.

Still referring to FIG. 8A, the molded meter pit frame 805 includes an upper ring surface 811 onto which may be molded various customizable logos or symbols. Located radially within the upper ring surface 811 is an inner lip 813 (obscured by the cover 806), configured to receive and support the cover 806. The upper ring surface 811 and the inner lip 813 collectively define a central opening which houses the cover 806 and which may, upon removal of the cover 806, provide access to a user to the equipment and/or instrumentation within the meter pit 870. The upper frame surface 817 extends radially outwards from the upper ring surface 811 to a radially outer frame edge 819.

FIG. 8B shows a side view of the molded meter pit frame 805 mounted on the straight wall-type meter pit 870 and having the bullet-nose extension component 850 disposed therebetween, in accordance with various embodiments. The upper frame surface 817 slopes downwardly as it extends radially outwards from the upper ring surface 811 to a radially outer frame edge 819, other slopes and/or geometries of the upper frame surface 817 also being contemplated. FIG. 8B illustrates the molded meter pit frame 705 as having retention members 721 extending downwardly from a lower surface 723 thereof, the retention members 721 configured to help position and secure the molded meter pit frame 705 to various structures, in this case the bullet-nose extension component 850.

FIG. 8C shows a side cross-sectional view of the molded meter pit frame 805 mounted on the straight wall-type meter pit 870 and having a bullet-nose extension component 850 disposed therebetween, taken along section C-C shown in FIG. 8B, in accordance with various embodiments. FIG. 8C shows that, on the underside of the upper frame surface 817, are various rib structures 825 that may include radially-extending ribs 825a that extend between the inner lip 813 and the outer frame edge 819 and ring-shaped ribs 825b that extend circularly around the central opening at various circumferential positions between the circular inner lip 813 and the circular outer frame edge 819. Retention members 821 may also be configured along the rib structures 825, with certain retention member 821a located circumferentially along the outer frame edge 819 and others, such as retention members 821b, being located radially inwardly therefrom.

Still referring to FIG. 8C, the molded meter pit frame 805 may also have a vertical wall 814 which extends downwardly from the inner lip 813. Disposed on the vertical wall 814 are vertical ribs 825c that provide additional stiffening and support to the molded meter pit frame 805, the vertical ribs 825c connected on one end to the inner lip 813 and on the other end to one of the ring-shaped rib 825b that extends circularly around the central opening. FIG. 8C shows the radially-extending ribs 825a extending at least partially from the lower frame surface 823 to the upper frame surface 811 to provide additional structural integrity and enabling the molded meter pit frame 805 to be relatively lightweight. The molded meter pit frame 805 also has a radially-inner sidewall 813a between the upper surface 811 and the inner lip 813 that allows the bottom surface 806b of the cover 806 to sit against the inner lip 813 with the top surface 806a of the cover 806 sitting flush with the upper surface 811 of the molded meter pit frame 805.

FIG. 8C also shows the metal locator ring 827 secured to the bottom surface 823 of the molded meter pit 805 via attachment screws 828. In this embodiment, the upper edge 8702 of the straight wall-type meter pit 870 is aligned with and sits against a lip 8501 of the bullet-nose extension component 850, with latch mechanisms 8503 (other securing mechanisms also being contemplated) securing the components together. Likewise, an upper lip 8502 of the bullet-nose extension component 850 is aligned with and sits against the bottom surface 823 of the molded meter pit frame 805. The bullet-nose extension component 850 may be dimensioned so as to enable any size molded meter pit frame 805 to attach to and/or seal with any size meter pit 870. The meter pit 870 is shown as having ribs 8701 for providing additional structural integrity.

As mentioned previously, a particular advantage of the above-described molded meter pit frames is that they may allow signals to be transmitted therethrough. It should also be recognized that the molded meter pit frames described herein may also include structural features that render them suitable for effectively securing various different types of antennae (even when existing antennae are replaced by new antennae having different sizes and configurations).

There are no limitations in terms of the particular embodiments described in this application, which are intended as illustrations of various aspects only. Many modifications and variations can be made without departing from its spirit and scope, as will be apparent to those skilled in the art. Functionally equivalent methods and apparatuses, in addition to those enumerated herein, will be apparent to those skilled in the art from the foregoing descriptions. Such modifications and variations are intended to fall within the scope of the appended claims. Only the terms of the appended claims are intended to be limiting, along with the full scope of equivalents to which such claims are entitled. It is also to be understood that the terminology used herein, e.g., “and”, “or”, “including”, “at least” as well as the use of plural or singular forms, etc., is for the purpose of describing examples of embodiments and is not intended to be limiting.

What is claimed is:

1. A meter pit frame configured to enclose an opening of a meter pit, the meter pit frame comprising:
an outer frame edge;
a circular inner wall defining a central opening from which extends a lip for receiving and supporting a cover; and
a plurality of ribs positioned between the inner wall and the outer frame edge and configured to enable the meter pit frame to support vertical loading, the plurality of ribs disposed entirely on an underside of the meter pit frame,
the meter pit frame molded from plastic and configured to enable transmission of data signals therethrough.

2. The meter pit frame of claim 1, further comprising:
the cover supported within the central opening by the lip.

3. The meter pit frame of claim 1, further comprising:
one or more retention or location members configured to retain or locate the meter pit frame to a meter pit.

4. The meter pit frame of claim 1, wherein the plurality of ribs include a circular rib surrounding the central opening and which is also disposed entirely on an underside of the meter pit frame.

5. The meter pit frame of claim 4, further comprising:
a locator component mounted to the circular rib and configured to be detectable to help locate the meter pit frame when the meter pit frame is underground or below grade.

6. The meter pit frame of claim 5, wherein the locator component is a metal ring or plate configured to be detected by a metal detector when the meter pit frame is underground or below grade.

7. The meter pit frame of claim 1, further comprising:
an expander ring configured to be mounted to the meter pit frame, the expander ring configured to change a meter pit diameter to which the meter pit frame is connectable.

8. The meter pit frame of claim 7, wherein the expander ring is further configured to be mounted to the meter pit.

9. The meter pit frame system of claim 1, further comprising:
an extension component configured to be mounted to the meter pit frame, the extension component configured to extend a distance between a meter pit diameter and the meter pit frame.

10. The meter pit frame of claim 1, wherein the meter pit frame may be molded from plastic, e.g. polypropylene, or composite, e.g. glass reinforced polypropylene or resins.

11. A meter pit frame system comprising:
a cover;
a molded meter pit frame including an outer frame edge and a circular inner wall defining a lip for receiving and supporting the cover, the molded meter pit frame also including a plurality of load-bearing ribs located below the top surface and extending between the inner wall and the outer frame edge; and
a meter pit configured to contain utility equipment,
the meter pit frame molded from plastic and configured to enable transmission therethrough of data signals to or from the utility equipment.

12. The meter pit frame system of claim 11, wherein the molded meter pit frame includes one or more retention or location members configured to secure or locate the meter pit frame to the meter pit.

13. The meter pit frame system of claim 11, wherein the plurality of ribs located below the top surface includes a circular rib surrounding the central opening of the meter pit frame.

14. The meter pit frame system of claim 13, further comprising:
a locator component mounted to the circular rib and configured to be detectable to help locate the meter pit frame when the meter pit frame is underground.

15. The meter pit frame system of claim 14, wherein the locator component is a metal ring configured to be detected by a metal detector when the meter pit frame is underground.

16. The meter pit frame system of claim 11, further comprising:
an expander ring configured to be mounted to the meter pit frame, the expander ring configured to change a meter pit diameter to which the meter pit frame is connectable.

17. The meter pit frame system of claim 11, wherein the expander ring is further configured to be mounted to the meter pit.

18. The meter pit frame system of claim 11, further comprising:
an extension component configured to be mounted to the meter pit frame, the extension component configured to extend a distance between a meter pit diameter and the meter pit frame.

19. The meter pit frame system of claim 11, wherein the meter pit frame may be molded from polypropylene, or composite, e.g. glass reinforced polypropylene or resins.

20. A molded meter pit frame configured to enclose an opening of a meter pit, the meter pit frame comprising:
an outer frame edge;
a circular inner wall defining a central opening from which extends a lip for receiving and supporting a cover; and
a smooth upper frame surface that slopes downwardly from the circular inner wall towards the outer frame edge,
the meter pit frame molded from plastic and configured to enable transmission of data signals therethrough.
